(19) United States
(12) Patent Application Publication
(10) Pub. No.: US 2023/0233985 A1
(43) Pub. Date: Jul. 27, 2023

(54) DAC MATERIALS

(71) Applicant: CLIMEWORKS AG, Zürich (CH)

(72) Inventors: Angelo VARGAS, Zúrich (CH); Christoph GEBALD, Zürich (CH); Davide ALBANI, Zürich (CH); Tobias NIEBEL, Zürich (CH)

(73) Assignee: CLIMEWORKS AG, Zürich (CH)

(21) Appl. No.: 18/012,173

(22) PCT Filed: Jun. 17, 2021
(86) PCT No.: PCT/EP2021/066443

§ 371 Date: Dec. 21, 2022

(30) Foreign Application Priority Data
Jun. 22, 2020 (EP) 20181440.7
Dec. 11, 2020 (EP) 20213511.7

(51) Int. Cl. B01D 53/047

(52) U.S. Cl. CPC B01D 53/047; B01D 2259/40009; B01D 2253/306; B01D 2253/308; B01D 2253/311; B01D 2253/25; B01D 2257/504; B01D 2259/4009

(57) ABSTRACT

Method for separating gaseous carbon dioxide from air, in particular from ambient atmospheric air (1), by cyclic adsorption/desorption using a sorbent material (3), wherein said sorbent material (3) is a solid inorganic or organic, non-polymeric or polymeric support material functionalized on the surface with amino functionalities capable of reversibly binding carbon dioxide, with a specific BET surface area, preferably measured by nitrogen adsorption, in the range of 1-20 m2/g.

### TECHNICAL FIELD

The present invention relates to uses of materials for separating gaseous carbon dioxide from a gas mixture, in particular for direct air capture (DAC) as well as to corresponding processes, in particular for the direct capture of carbon dioxide from atmospheric air.

### PRIOR ART

The Paris Agreement led to a consensus about the threat of climate change and the need of a global response to keep the global temperature rise well below 2 degrees Celsius above pre-industrial levels. To achieve this target, multiple possibilities have been suggested, from the planting of new forests to technological means. Forestation has broad resonance with the public opinion but the scope and feasibility of such projects is debated and is likely to be less simple an approach as believed.

Among the technological approaches, the most advanced technologies include sequestration of CO2 from point sources such as flue gas capture, and direct capture of CO2 from air, referred to as direct air capture (DAC). Both technological strategies have potential to mitigate climate change.

The specific advantages of CO2 capture from the atmosphere over flue gas capture include: DAC (i) can address the emissions of distributed sources (e.g. cars, planes); (ii) does not need to be attached to the source of emission but can be at a location independent thereof; (iii) can address emissions from the past thus enabling negative emissions if combined with a safe and permanent method to store the CO2 (e.g., through underground mineralization). DAC is also used as one of several means of providing a key reactant for the synthesis of renewable materials or fuels as e.g. described in WO-A-2016/161998.

In terms of suitable capture material, several DAC technologies have been described in literature, such as for example, the utilization of alkaline earth oxides in water to form calcium carbonate as described in e.g. US-A-2010034724. Different approaches comprise the utilization of solid CO2 adsorbents, hereafter named sorbents, which are characterized by the use of a packed bed and where CO2 is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346. WO-A-2011/049759 describes the utilization of an ion exchange material comprising an aminoalkylated bead polymer for the removal of carbon dioxide from industrial applications. WO-A-2016/037668 describes a sorbent for reversibly adsorbing CO2 from a gas mixture, where the sorbent is composed of a polymeric adsorbent having a primary amino functionality and a having a high specific surface area (calculated with the Brunauer-Emmet-Teller method) of 25-75 m2/g and a specific average pore diameter. The materials are regenerated after capture by applying pressure or humidity swing.

WO-A-2016/038339 describes a process for removing carbon dioxide using a polymeric adsorbent having primary amine units immobilized on a solid support. The regeneration of the sorbent is then done by heating the sorbent in a temperature range between 55 and 75° C. while flowing air through it.

U.S. Pat. Nos. 6,716,888 and 6,503,957 describe a process for introducing ground ion exchange resins into a polymer binder melting at temperatures of 125-130° C. and forming the heterogeneous mixture into a sheet form of maximum thickness 0.125 mm for usage in water purification.

US-A-2012076711 discloses a structure containing a sorbent with amine groups that is capable of a reversible adsorption and desorption cycle for capturing CO2 from a gas mixture wherein said structure is composed of fiber filaments wherein the fiber material is carbon and/or polyacrylonitrile.

US-A-2018043303 discloses a porous adsorbent structure that is capable of a reversible adsorption and desorption cycle for capturing CO2 from a gas mixture and which comprises a support matrix formed by a web of surface modified cellulose nanofibers. The support matrix has a porosity of at least 20%. The surface modified cellulose nanofibers consist of cellulose nanofibers having a diameter of about 4 nm to about 1000 nm and a length of 100 nm to 1 mm that are covered with a coupling agent being covalently bound to the surface thereof. The coupling agent comprises at least one monoalkyldialkoxyaminosilane. US-A-2019224647 provides novel solid sorbents synthesized by the reaction of polyamines with polyaldehyde phosphorous dendrimer (P-dendrimer) compounds. The sorbents are stable and exhibit rapid reaction kinetics with carbon dioxide, making the sorbents applicable for carbon capture, and can be easily regenerated for further use. The material is stable to aqueous and organic media, as well as strong acid and bases. The sorbent maintains full capacity over extended use. The material can be used for CO2 capture from pure CO2 streams, mixed gas streams, simulated flue gas, and ambient air. Additionally, the material can be adhered to surfaces for reversible CO2 capture applications outside of bulk particle-based processes.

US-A-2017203249 discloses a method for separating gaseous carbon dioxide from a mixture by cyclic adsorption/desorption using a unit containing an adsorber structure with sorbent material, wherein the method comprises the following steps: (a) contacting said mixture with the sorbent material to allow said gaseous carbon dioxide to adsorb under ambient conditions; (b) evacuating said unit to a pressure in the range of 20-400 mbarabs and heating said sorbent material with an internal heat exchanger to a temperature in the range of 80-130° C.; and (c) re-pressurisation of the unit to ambient atmospheric pressure conditions and actively cooling the sorbent material to a temperature larger or equal to ambient temperature; wherein in step (b) steam is injected into the unit to flow-through and contact the sorbent material under saturated steam conditions, and wherein the molar ratio of steam that is injected to the gaseous carbon dioxide released is less than 20:1.

Irani et al (“Facilely synthesized porous polymer as support of poly (ethyleneimine) for effective CO2 capture”, Energy (157), p. 1-9 (2018)) proposes an effective adsorbent (polyHIPE/PEI) for use in CO2 capture technologies. For this purpose, a porous polymer was prepared by high internal phase emulsion (HIPE) using 2-Ethylhexyl methacrylate (EHMA) and divinylbenzene (DVB). This prepared porous polymer (polyHIPE) was then used as a novel support for the wet impregnation of polyethylenimine (PEI), thus resulting in the polyHIPE/PEI adsorbent. The prepared adsorbent was characterized. At the optimal PEI loading of 60 wt % on polyHIPE, the CO2 sorption capacity reached 4 mmol CO2/g-sorbent using 10 vol % C02 and 3 vol % H2O in N2 at 70° C. Kinetic and thermodynamic adsorption studies showed that the activation energies for CO2 adsorption and desorption of polyHIPE/PEI are 13.74 kJ/mol and 36.12 kJ/mol, respectively.

### SUMMARY OF THE INVENTION

The present invention relates to methods for separating gaseous carbon dioxide from a gas mixture, preferably from at least one of ambient atmospheric air, flue gas and biogas, in particular to DAC methods, using a particular material as well as to uses of such particular materials for gas separation purposes, in particular DAC.

Herein it is shown that, contrary to prior art that claims that cross-linked polystyrene sorbents substituted with primary aminoalkyl functional groups and featuring a specific surface area above 25 m2/g are useful for DAC applications, surprisingly inorganic or organic, non-polymeric or polymeric materials, in particular cross-linked polystyrene sorbents, functionalized with amino groups (from here on referred to AFM for amino-functionalized materials, or CPFA for cross-linked polymeric sorbent functionalized with amino groups) having a specific surface area in the range 1-20 m2/g, preferably further a pore volume in the range 0.05-0.50 cm3/g, and/or preferably a pore diameter between 50-300 nm, and/or preferably a nitrogen content expressed in weight % (referred as wt. %) in the range 5-50 wt. % are especially efficient sorbents for the capture of carbon dioxide, and more especially in cyclic adsorption/desorption operations.

In the following discussion we will refer to such materials as described above as Low Surface Area AFM or in particular Low Surface Area CPFA, or LSA-AFM or LSA-CPFA respectively, to distinguish them from materials based on essentially the same chemical composition but—having a specific surface area significantly above 25 m2/g. Prior art does not disclose LSA-AFM, let alone LSA-CPFA, functionalized with primary aminoalkyl functional groups for DAC applications. It is thus the object of the present invention to disclose LSA-AFM materials, in particular LSA-CPFA materials, functionalized with primary aminoalkyl functional groups that are especially feasible for separating gaseous carbon dioxide from a gas mixture, in particular the direct capture of carbon dioxide from atmospheric air.

These materials can be polymeric or non-polymeric. The materials can also be organic or inorganic, but also hybrid forms are possible. The main characterizing feature of these materials is not so much the chemistry, but the physical properties of the porous structure. In particular, it shows that if the functionalized solid support has a porosity in the claimed range and has a high proportion of macropores (pores with diameters exceeding 50 nm) and further preferably also has a low proportion or is essentially free from mesopores i.e. pores with diameters between 2 and 50 nm, and/or preferably also has a low proportion or is essentially free from micropores i.e. pores with diameters not exceeding or below 2 nm, this leads to a reduction of accumulation of condensed water in the porosity and for the carbon dioxide capture process in the presence of water and/or steam to a much higher capacity in cyclic operation.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of −40 to 60° C., more typically −30 to 45° C. The gas mixture used as input for the process is preferably ambient atmospheric air, i.e. air at ambient atmospheric pressure and at ambient atmospheric temperature, which normally implies a CO2 concentration in the range of 0.03-0.06% by volume. However, also air with lower or higher CO2 concentration can be used as input for the process, e.g. with a concentration of 0.1-0.5% by volume, so generally speaking preferably the input CO2 concentration of the input gas mixture is in the range of 0.01-0.5% by volume.

To the person skilled in the art, it is known that the properties of the ambient atmospheric air to which the sorbent material is exposed in terms of both temperature and humidity range have a strong influence on the performance of amine-based sorbents. For example, in dry conditions (i.e., relative humidity, RH=0%) amines show an efficiency, defined as the stoichiometric coefficient of the reaction between the amino group and CO2, of 2:1, while in humid conditions the efficiency is of 1:1. Prior art discloses the benefits of high relative humidity of the gas stream containing carbon dioxide on the adsorption capacity, defined as the mole of CO2 captured per kilogram of sorbent, during the adsorption step. Prior art does not disclose the effect of high relative humidity of the gas stream containing CO2 on the cyclic adsorption/desorption performance of AFM type, in particular CPFAs type, sorbent.

Weakly basic AFM materials, in particular CPFAs, typically retain between 30-70 wt. % of water. This feature is of importance for liquid chromatography, the most common application. In the present invention we propose the utilization of such AFM materials, in particular CPFA, having a water content in the range 5-30% preferably 10-30 wt. %, which is much more beneficial for the kinetics of carbon dioxide adsorption.

In the present invention, we show the benefits of solid sorbents made of AFM materials, in particular CPFA, in a cyclic DAC adsorption/desorption process, wherein the sorbent material has a specific surface area in the range 1-20 m2/g, wherein the gas stream containing CO2 features typically RH % values larger than 75%, wherein the warm fluid for desorption can be saturated steam that enables the desorption of CO2, wherein the water formed by steam condensation is totally or partially accumulated on the sorbent.

AFM materials, in particular CPFA, featuring the specific surface area reported in the prior art (i.e., 25-75 m2/g) present a strong decay in adsorption capacity in cyclic adsorption/desorption operations in particular when the gas stream containing CO2 features a RH % larger than 75%. This phenomenon has never been reported and severely limits the scope of utilization of the previously disclosed AFM materials, in particular CPFAs, for applications in particular in DAC. Atmospheric conditions of relative humidity vary greatly during different times of the day, during different seasons and in different regions of the planet. The stability of a process exposed to air at varying conditions of RH % is a fundamental feature for the economy of DAC. AFM sorbents, in particular CPFA sorbents, featuring a specific surface area in the range 1-20 m2/g and operating in a cyclic adsorption/desorption process and with a gas stream featuring a RH % that covers the whole spectrum of RH % and that can therefore also reach RH % larger than 75%, in particular where the desorption is conducted with saturated steam, have the unique feature of presenting stable cyclic CO2 adsorption over many cycles (>20). The material reported in this invention can retain fast adsorption kinetics of CO2 from ambient air also at high RH %. This ensures a stable adsorption and desorption capacities, thus allowing for economically viable and lower energy intensity processes. So if the gas stream has high RH %, the process in nonetheless robust, when one uses low surface area sorbents as proposed here, while it will show a decrease in cyclic capacity if the BET surface is higher. This does not necessarily limit the invention to high RH % but allows working with continuity along the whole spectrum of RH % without interruption and capacity loss.

More generally speaking, the present invention proposes a method for separating gaseous carbon dioxide from a gas mixture, preferably from ambient atmospheric air, containing said gaseous carbon dioxide as well as further gases different from gaseous carbon dioxide, by cyclic adsorption/desorption using a sorbent material adsorbing said gaseous carbon dioxide in a unit. If in the following reference is made to ambient atmospheric air, this also includes other gas mixtures like flue gas and biogas.

The method comprises at least the following sequential and in this sequence repeating steps (a)-(e):

(a) contacting said gas mixture, preferably ambient atmospheric, air with the sorbent material to allow at least said gaseous carbon dioxide to adsorb on the sorbent material by flow-through through said unit, preferably under ambient atmospheric pressure conditions (if ambient atmospheric air is pushed through the device using a ventilator for the like, this is still considered ambient atmospheric pressure conditions in line with this application, even if the air which is pushed through the reactor by the ventilator has a pressure slightly above the surrounding ambient atmospheric pressure, and the pressures to is in the ranges as detailed above in the definition of “ambient atmospheric pressures”) and ambient atmospheric temperature conditions, in an adsorption step;

(b) isolating said sorbent material with adsorbed carbon dioxide in said unit from said flow-through preferably while maintaining the temperature in the sorbent;

(c) injecting a stream of saturated or superheated steam by flow-through through said unit and thereby inducing an increase of the temperature of the sorbent material to a temperature between 60 and 110° C., starting the desorption of CO2;

(d) extracting at least the desorbed gaseous carbon dioxide from the unit and separating gaseous carbon dioxide from steam by condensation downstream of the unit;

(e) bringing the sorbent material to ambient atmospheric temperature conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature+25° C., preferably +10° C. or +5° C.). As pointed out above, according to the invention said sorbent material is a solid inorganic or organic, non-polymeric or polymeric support material functionalized on the surface with amino functionalities capable of reversibly binding carbon dioxide, which has a specific BET surface area, determined by applying the BET method as described in ISO 9277, and preferably based on measurements of nitrogen adsorption, in the range of 1-20 m2/g. So BET (Brunauer, Emmett und Teller) surface area analysis is used for the determination of the specific BET surface area applying the method as described in ISO 9277.

According to a first preferred embodiment, said sorbent material has a specific BET surface area, preferably measured by nitrogen adsorption, in the range of 2-15 m2/g, preferably in the range of 4-10 m2/g or 5-10 m2/g.

Further preferably said sorbent material has a pore diameter distribution, measured by Mercury intrusion, such that 90%, preferably 95% of the pore volume is in the range of 50-300 nm, preferably in the range of 50-250 nm. For the parameters used for the Mercury intrusion measurements reference is made to the details in the specification further below. Alternatively or additionally, said sorbent material preferably has a pore volume distribution, measured by Mercury intrusion, such that the maximum pore volume is at a pore diameter in the range of 80-150 nm, preferably in the range of 100-150 nm. The distribution is preferably such that 90%, more preferably 95% of the total pore volume of the distribution is in a window of −50 nm and +150 nm, preferably of −40 and +100 nm around the diameter of said maximum of the pore volume distribution.

According to yet another preferred embodiment, said sorbent material has a total pore volume, measured by Mercury intrusion, in the range 0.05-0.50 cm3/g, preferably 0.10-0.40 cm3/g, most preferably in the range of 0.15-0.35 cm3/g.

The sorbent material can also be characterised by way of its nitrogen content. According to another preferred embodiment, said sorbent material thus has a nitrogen content in the range 5-50 wt. %, preferably in the range or 9-15 wt. % or 10-12 wt. %, in each case for dry sorbent material. The dryness for this determination is defined as treating 6 g of the sorbent material at 90° C. for 90 min under a N2 flow of 2 L/min-

As pointed out above, the method can be carried out basically at any practical relative humidity (RH %), but has the advantage, that it is particularly suitable and stable if during certain phases of the process the RH % is above 70% or even above 75%. Preferably, the method is carried out under conditions that the gas mixture or the ambient atmospheric air passing through the sorbent material in step (a), at least during one cycle or at least during 5% of the cycles, has a relative humidity of at least 70%, preferably of at least 75%.

The solid inorganic or organic, non-polymeric or polymeric support material can be based on an organic or inorganic, preferably organic polymeric support, for example thermoplastic or thermoset materials. Also possible are thermoplastic materials, which are cross-linked in a subsequent step to synthesis. The solid polymeric support material can be cross-linked polymeric material such as a polystyrene or polyvinyl material, which can be cross-linked by using divinyl aromatics, preferably a styrene divinylbenzene copolymer (poly(styrene-co-divinylbenzene)). The solid support material can be in the form of beads which can be monodisperse or heterodisperse.

The solid inorganic or organic, non-polymeric or polymeric support material can also be an inorganic non-polymeric support, preferably selected from the group consisting of: silica (SiO₂), alumina (Al₂O₃), titania (TiO₂), magnesia (MgO), clays, as well as mixed forms thereof, such as silica-alumina (SiO₂—Al₂O₃), or mixtures thereof.

The solid support material can be in the form of hollow or solid particles, beads, microspheres, monolithic structures, sheets, hollow or solid fibres, preferably in woven or nonwoven structures, or extrudates.

The solid inorganic or organic, non-polymeric or polymeric support material can also take the form of particles (powders or granules, e.g. having an average size (D50) between 0.002 and 4.0 mm) of such a support material, which can be embedded in a solid matrix in the form of a composite.

When talking about a solid matrix forming the solid inorganic or organic, non-polymeric or polymeric support material as a composite in the context of this aspect of the invention, this means that the solid matrix conclusively provides for the actual three-dimensional structure forming the solid inorganic or organic, non-polymeric or polymeric support material. So this aspect does not include situations where a separate structure provides for an actual carrier which is then coated, impregnated or soaked with a binder forming a solid matrix with the particles and subsequently dried, cross-linked or solidified in another way, and where the binder provides for adhering the particles to the actual carrier and/or forming a coating on that carrier together with the particles. According to this aspect of the invention, the solid matrix together with the particles at least partly embedded therein provides for the actual solid inorganic or organic, non-polymeric or polymeric composite. So the composite is essentially formed exclusively by the solid matrix and the particles.

Preferably, the composite formed exclusively by the solid matrix and the particles and takes the form of sheets or foils, but also granules or monolithic structures are possible. These elements providing the solid inorganic or organic, non-polymeric or polymeric composite can be mounted in a corresponding carrier structure, for example in some kind of a frame or the like for the actual carbon dioxide capture process.

In particular foils or sheets of such a composite material including the solid inorganic or organic, non-polymeric or polymeric support material can be obtained by extrusion, wherein e.g. said particles are added to for example a thermoplastic matrix material after melting thereof and prior to the thermoforming. This is possible by melt mixing or solution casting but it is also possible by sputtering particles onto a liquid or at least surface softened layer of the thermoplastic material of the solid matrix if need be followed by a lamination process between rolls.

Alternatively it is possible to use a precursor material of the solid matrix, add the particles to that precursor material, mix it, and then solidify the material, for example in a cross-linking, sintering or drying process, leading for example to a thermoset structure. Preferably in such a process involving heating it is made sure that the residence time of the particles in the molten or precursor material is sufficiently short to avoid degradation of the surface and/or porosity properties and/or of the functionalisation of the particles.

Further it is possible to generate the actual adsorber structure starting out from sorbent material particles in a sintering process, e.g. by bringing the sorbent material particles into a corresponding desired three-dimensional shape (e.g. into the form of a layer of essentially the desired thickness for the resulting foil) and to then heat and/or irradiate and/or chemically treat the corresponding structure similar to a sintering process to generate a coherent macroscopic adsorber structure. This is particularly suitable for sorbent materials based on organic thermoplastic polymeric materials. It is however e.g. also possible for other materials if these materials are provided with a corresponding binder on the surface allowing for such a sintering process. Such a sintering can be assisted by slight pressing, e.g. in a lamination process.

The solid matrix can again be a same or different solid inorganic or organic, non-polymeric or polymeric support material functionalized on the surface with amino functionalities, preferably having itself the surface and porosity properties as defined above. However it can also be a material which is different from the one of the particles and does not have a carbon dioxide capture property and/or whose matrix does not have the surface area and porosity characteristics as defined above. Preferably, the solid matrix in this case is a different material from the particles which does not have a surface functionalisation but which is preferably porous and in which the particles are exposed on the surface with their functionalised surface to be able to act as carbon dioxide capture moieties.

Also such a composite form material with particles embedded in solid matrix can be in the form of hollow or solid particles, beads, microspheres, monolithic structures, sheets, hollow or solid fibres, preferably in woven or nonwoven structures, meshes, or extrudates.

A corresponding powder to be embedded in a matrix can be obtained by milling or grinding a particulate resin material which is already surface functionalised.

Such sheets or foils preferably have a thickness in the range of 0.01-2 mm, preferably in the range of 0.1-1 mm, for the envisaged DAC applications to provide for the required mechanical properties.

To withstand the conditions of typical DAC processes, it is furthermore preferable that the solid matrix material with the embedded particles forming the composite structure and/or the solid inorganic or organic, non-polymeric or polymeric support material in general, at the typical DAC processing conditions, does not or at least not significantly lose its mechanical properties to an extent impairing the performance in the DAC process.

Therefore typically, in case of amorphous thermoplastic polymeric materials for the solid matrix or the support material in general, the glass transition temperature should be higher than 100° C., and in case of thermoplastic systems with a melting point, the melting point should be higher than 100° C. On the other hand, considering in particular particles which are already functionalised when combined with the matrix, and very particularly considering such polymeric particles, e.g. based on polystyrene, which on the surface is functionalised, the matrix material should not have a processing temperature which is too high, since otherwise in the melt mixing process the polymeric particles will also melt and/or the surface functionalisation of the particles will be destroyed. Considering this, the matrix material and/or support material in general should preferably have, in case of amorphous thermoplastic polymeric materials, a glass transition temperature lower than 180° C. In case of amorphous thermoplastic polymeric materials preferably the glass transition temperature is therefore in a range of 120-160° C., more preferably in the range of 130-150° C. In case of matrix systems and/or support material in general having a melting point (e.g. microcrystalline or partly crystalline polymeric systems), the melting point or softening point should be in the range of the same temperatures, so it should be higher than 100° C., and/or lower than 180° C., preferably in the range of 120-160° C., more preferably in the range of 130-150° C. Glass transition temperatures and melting temperatures in the present context are to be considered measured according to DIN EN ISO 11357 (2012). Amorphous in the sense of the present invention means that the system has an enthalpy of fusion determined according to ISO 11357 (2012) of less than or equal to 3 J/g.

It should be noted that the above-mentioned surface area properties and the porosity properties are to be considered in as far as they are relevant for the carbon dioxide capture process. If therefore for example a matrix material is permeable for carbon dioxide, the composite may have a porosity and/or surface area structure which is not within the ranges as claimed and as given above, since that is determined largely by the solid matrix material. However the particles embedded in such a material do have the porosity and/or surface area structure as defined above, and these properties are available for the carbon dioxide capture process by virtue of the fact that the matrix material is permeable to the carbon dioxide and allows access to the capture active particles by way of diffusion.

So such a composite structure can for example be produced by blending the particles with the solid matrix material or a predecessor thereof, and subsequent solidification and/or extrusion. So the solid matrix material can for example be a thermoplastic material or a material which only solidifies upon treatment after mixture, e.g. in a cross-linking or drying or sintering process.

Surface functionalisation for carbon dioxide capture in this case can either be carried out before blending and forming the corresponding composite, or after. Possible is for example also a process, in which the particles without functionalisation and the matrix material are mixed, a corresponding porous composite structure is generated having the desired porosity characteristics, and subsequently the functionalisation on the surface of the embedded particles with amino functionalities is carried out on the solid composite structure. This has the advantage that a non-functionaliseable matrix material can be combined with functionaliseable particles in a composite, the composite is first generated and the composite is only subsequently and only on the corresponding available surface of the particles functionalised with amino functionalities as defined above. This composite is then to be regarded as a sorbent material in the above sense, or the particles embedded in the composite are to be regarded as a sorbent material in the above sense.

Such a solid support is preferably surface functionalised to form the sorbent material, wherein preferably the surface functionalisation leads to amine groups available for reversible carbon dioxide capture wherein the surface functionalization can be achieved by impregnation or by grafting with a surface species of the solid support, or a combination thereof. The surface functionalization is preferably provided with amino methyl moieties such as benzylamine moieties, wherein the solid polymeric support material is preferably obtained in an emulsion polymerisation process. Emulsion polymerisation can be efficiently used to establish the porosity in the claimed range by adapting the reactants and the reaction conditions, and preferably the emulsion polymerisation is carried out in water with or without using a surfactant such as dimethyldioctadecaylammonium chloride, preferably in the presence of a pore-forming agent, which can be isooctane, toluene, wax or a mixture thereof. But also other methods and reagents are possible. Functionalisation can for example be achieved by phthalimide addition or chloromethylation. Preferably, the primary amine moieties take the form of terminal amino methyl, e.g. in the form of the above-mentioned benzylamine moieties. For carbon dioxide capture, the primary amine is, according to present knowledge, converted to a carbamic acid compound, which dissociates a high temperature and/or humidity for the release of the carbon dioxide.

The solid inorganic or organic, non-polymeric or polymeric support material can be a polymeric support material in the form of at least one of monolith (typically having a sponge-like structure for flow-through of gas mixture/ambient air), the form of a layer or a plurality of layers, sheets, the form of hollow or solid fibres, for example in woven or nonwoven (layer) structures, but can also take the form of hollow or solid particles (beads). Preferably it takes the form of preferably essentially spherical beads with a particle size (D50) in the range of 0.002-4 mm. 0.005-2 mm or 0.01-1.5 mm, preferably in the range of 0.30-1.25 mm. Possible are also particles with a particle size (D50) in the range of 0.002-1.5 mm, 0.005-1.6 mm.

In the unit the sorbent material, if it takes the form of beads, can be contained in layered containers having air permeable side walls in the form of metal grids or the like, having a mesh width which is sufficiently large to provide for a low pressure drop across the corresponding structure, but sufficiently small to make sure that the particles of the sorbent material are retained in the corresponding containers.

The sorbent material can have a water retention in the range of 3-60 weight percent, preferably in the range of 3-30 weight percent or 5-30 weight percent. The water retention in this case is determined using a moisture analyser which heats up the sorbent material to 110° C. until the weight change detected is not larger than 0.002 g/15 seconds.

Furthermore, the sorbent material can have a bulk density (EN ISO 60 (DIN 53468)) in the range 750-400 kg/m3, preferably 450-650 kg/m3.

Step (d) of extraction is preferably carried out while still contacting the sorbent material with steam by injecting and/or circulating saturated or superheated steam into said unit, thereby flushing and purging both steam and CO2 from the unit, and preferably while regulating the extraction and/or steam supply to essentially maintain the temperature in the sorbent at the end of the preceding step (c) and/or to essentially maintain the pressure in the sorbent at the end of the preceding step (c). “Essentially maintaining the pressure in the sorbent at the end of the preceding step” in practice means that the pressure is not allowed to deviate more than by ±100 mbar, preferably more than ±50 mbar, more preferably more than ±20 mbar from the pressure at the end of step (c). In practice certain very short time deviations even beyond this range may be produced after transitioning from step c) to d) due to processes of pressure equalization and depend on the exact realization of the equipment for carrying out the process. However they are of short duration on the order of less than 15% of the duration of step d).

For carrying out the method preferably a unit is used containing said sorbent material, the unit and the sorbent material being able to sustain a temperature of at least 60° C. for the desorption of at least said gaseous carbon dioxide and the unit being openable to flow-through of the gas mixture/ambient atmospheric air and for contacting it with the sorbent material for the adsorption step.

The unit used may comprise an array of individual adsorber elements, each adsorber element comprising at least one support layer and at least one sorbent layer comprising or consisting of at least one sorbent material, where said sorbent material offers selective adsorption of CO2 in the presence of moisture or water vapor, wherein the adsorber elements in the array can be arranged essentially parallel to each other and spaced apart from each other forming parallel fluid passages for flow-through of gas mixture/ambient atmospheric air and/or steam. Essentially parallel in this context means that angles between the planes of the adsorber elements when seen over the complete lengths of the adsorber elements do not exceed a value of 10°, preferably do not exceed a value of 5°, preferably are smaller than 2°. Individual adsorber elements in this context means that the adsorber elements are not a monolithic structure but can be independently from one another arranged to form essentially parallel channels of an array wherein the layers are connected to each other with corresponding linking structures, for example by way of a rack into which the layers are inserted or at which the layers are fastened or over which a support layer can be repeatedly pleated at a desired spacing.

Said unit is preferably evacuable to a vacuum pressure of 400 mbar(abs) or less, and step (b) may include isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

Preferably, after step (d) and before step (e) the following step is carried out:

(d1) ceasing the injection and, if used, circulation of steam, and evacuation of the unit to pressure values between 20-500 mbar(abs), preferably in the range of 50-250 mbar(abs) in the unit, thereby causing evaporation of water from the sorbent and both drying and cooling the sorbent.

Step (e) is preferably carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

After step (b) and before step (c) the following step can be carried out:

(b1) flushing the unit of non-condensable gases by a stream of non-condensable steam while essentially holding the pressure of step (b), preferably holding the pressure of step (b) in a window of ±50 mbar, preferably in a window of ±20 mbar and/or holding the temperature below 75° C. or 70° C. or below 60° C., preferably below 50° C.

In a further embodiment of the step b1, the temperature of the adsorber structure rises from the conditions of step (a) to 80-110° C. preferably in the range of 95-105° C.

In step (b1) the unit can preferably be flushed with saturated steam or steam overheated by at most 20° C. in a ratio of 1 kg/h to 10 kg/h of steam per liter volume of the adsorber structure, while remaining at the pressure of step (b1), to purge the reactor of remaining gas mixture/ambient air. The purpose of removing this portion of ambient air is to improve the purity of the captured CO₂.

In step (c), steam can be injected in the form of steam introduced by way of a corresponding inlet of said unit, and steam can be (partly or completely) recirculated from an outlet of said unit to said inlet, preferably involving reheating of recirculated steam, or by the re-use of steam from a different reactor.

It should be noted that heating for desorption according to this process in step (c) is only effected by this steam injection and there is no additional external or internal heating e.g. by way of tubing with a heat fluid.

In step (c) furthermore preferably the sorbent can be heated to a temperature in the range of 80-110° C. or 80-100° C., preferably to a temperature in the range of 85-98° C.

According to yet another preferred embodiment, in step (c) the pressure in the unit is in the range of 700-950 mbar(abs), preferably in the range of 750-900 mbar(abs).

In addition, the present invention relates to the use of a sorbent material having a solid inorganic or organic, non-polymeric or polymeric support material functionalized on the surface with amino functionalities capable of reversibly binding carbon dioxide, with a specific BET surface area, preferably measured by nitrogen adsorption, in the range of 1-m2/g, for direct air capture, in particular using a temperature, vacuum, or temperature/vacuum swing process.

Preferably this is using a process in which injecting a stream of saturated or superheated steam by flow-through is used for inducing an increase of the temperature of the sorbent material to a temperature between 60 and 110° C., starting the desorption of CO2. Preferably, the sorbent material for this use is characterised as detailed above in terms of pore diameter, pore volume, nitrogen content, et cetera.

Last but not least the present invention relates to a direct air capture unit comprising at least one reactor unit containing sorbent material suitable and adapted for flow-through of gas mixture, preferably ambient air,

wherein the reactor unit comprises an inlet for gas mixture/ambient air and an outlet for gas mixture/ambient air during adsorption,

wherein the reactor unit is heatable to a temperature of at least 60° C. for the desorption of at least said gaseous carbon dioxide and the reactor unit being openable to flow-through of the gas mixture/ambient atmospheric air and for contacting it with the sorbent material for an adsorption step, wherein preferably the reactor unit is further evacuable to a vacuum pressure of 400 mbar(abs) or less, wherein the sorbent material preferably takes the form of an adsorber structure comprising an array of individual adsorber elements, each adsorber element preferably comprising at least one support layer and at least one sorbent material layer comprising or consisting of at least one sorbent material, where said sorbent material comprises a solid inorganic or organic, non-polymeric or polymeric support material functionalized on the surface with amino functionalities capable of reversibly binding carbon dioxide, with a specific BET surface area, preferably measured by nitrogen adsorption, in the range of 1-20 m2/g, which offers selective adsorption of CO2 in the presence of moisture or water vapor, wherein preferably the adsorber elements in the array are arranged essentially parallel to each other and spaced apart from each other forming parallel fluid passages for flow-through of gas mixture/ambient atmospheric air and/or steam,

at least one device, preferably a condenser, for separating carbon dioxide from water, wherein preferably at the gas outlet side of said device for separating carbon dioxide from water, preferably said condenser, there is at least one of, preferably both of a carbon dioxide concentration sensor and a gas flow sensor for controlling the desorption process.

The present application also relates to methods for producing surface functionalized solid support materials suitable and adapted for these processes, in particular including surface impregnation or grafting for surface functionalization.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic representation of a direct air capture unit;

FIG. 2 shows N2 adsorption/desorption isotherms of HSA-CPFA and LSA-CPFA at 77 K;

FIG. 3 shows the pore size distribution measured by Hg porosimetry of HSA-CPFA and LSA-CPFA;

FIG. 4 shows the adsorption capacity of the sorbents HSA-CPFA and LSA-CPFA at 30° C. and 60% RH;

FIG. 5 shows the desorption capacity of the sorbents HSA-CPFA and LSA-CPFA after air adsorption at increasing RH values;

FIG. 6 shows the adsorption capacity of the sorbents HSA-ISAP and LSA-ISAP at 30° C. and 60% RH.

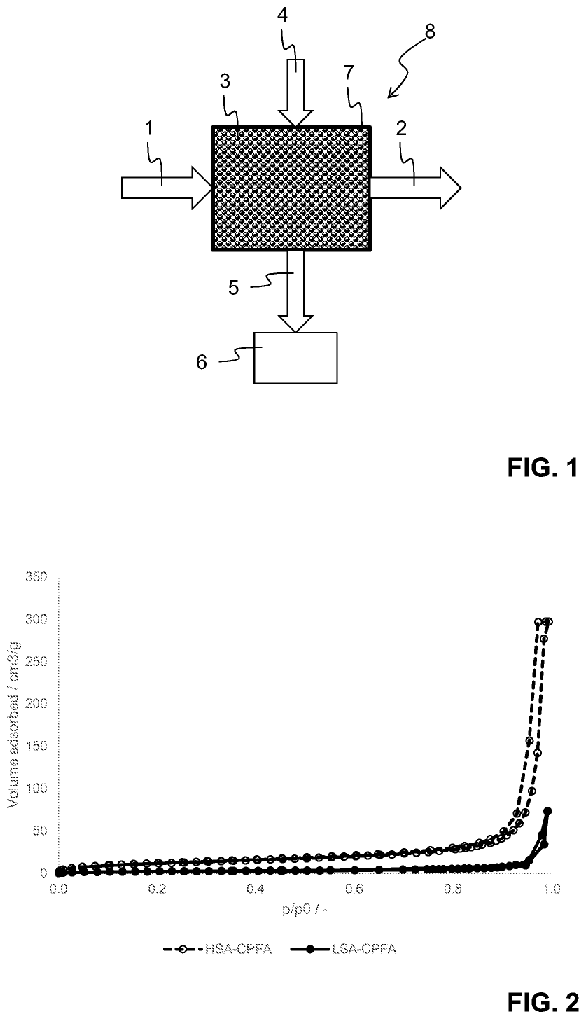

### DESCRIPTION OF PREFERRED EMBODIMENTS

In one embodiment, low surface area cross-linked polystyrene sorbent functionalized with amino groups (LSA-CPFA) functionalized with primary aminoalkyl functional groups in the form of beads of a styrene-divinylbenzene cross-linked polymer with an average particle size (d50) between 0.01-1.50 mm, functionalized with benzylamine units bound to the polymeric matrix, where the amine is a free base, is utilized as DAC sorbent in a packed bed configuration.

In another embodiment of the present invention, LSA-CPFA functionalized with primary aminoalkyl functional groups is used in the form of a monolith structure to filter CO2 from a gas mixture or preferably ambient air.

In another embodiment of the present invention, LSA-CPFA functionalized with primary aminoalkyl functional groups is used in the form of powder coated on a filter structure such as, but not limited to, a monolith, a laminate, fibers, polymers, metal structures.

In another embodiment of the present invention LSA-CPFA functionalized with primary aminoalkyl functional groups is used for capturing carbon dioxide from atmospheric air where the desorption step is performed by increasing the temperature of the sorbent and applying vacuum and/or saturated and superheated steam, and/or by applying temperature vacuum swing and by using a warm fluid wherein the warm fluid can be, but is not limited to, saturated and superheated steam. In such a method preferably at least a part of the desorption of CO2 is performed at a pressure in the range of 50-1000 mbarabs preferably of 100-950 mbarabs and at a temperature in the range of 50-150° C.

The low surface area material can be produced using a process as follows:

300 g of deionized water and 10 g of dispersant is added to a three-neck 1 L flask equipped with a thermometer and a reflux condenser at room temperature. To this mixture, a mixture containing 150 g of styrene, 25 g of divinylbenzene, 1.5 g of benzoyl peroxide and 90 g of pore-forming agent, which can be isooctane, toluene, wax or a mixture of thereof, is added under stirring. The temperature is increased to 70° C. for 3 h, then up to 80° C. for 4 h and completed at 95° C. for 7 h, after which the formation of the beads has occurred. The suspension is cooled down to room temperature. The beads are filtered and are then washed three times with an equivalent volume of acetone. 100 g of styrene-divinylbenzene and 220 mL of chloromethyl ether are added to a 1 L flask and left to swell for 3 h at room temperature. To this mixture, 3 g of zinc chloride is added and the temperature is increased to 45° C. for 16-24 h. The chloromethylated beads are then filtered and washed three times with an equivalent volume of methyl alcohol.

To obtain the aminomethylated polymer, the chloromethylated beads are treated in the following way. 100 g of chloromethylated beads and 100 g of deionized water are mixed, and then 40 g of a 200 g/L ammonia solution is added to the beads over 3 h maintaining the temperature between 3-30° C. The reaction mixture is then held for 3 h at 40° C. After cooling, 30 g of sodium hydroxide is added and the mixture is distilled. The beads are filtered and washed with hot water for 3 h.

### Specific Examples

In this example section, two samples have been analyzed and compared: one with high surface area as disclosed in the prior art e.g. of the type Lewatit VP OC1065 as available from Lanxess, Germany, having a BET surface area >25 m2/g, which is herein after referred to high surface area polymer (HSA-CPFA); and the second one with low surface area, <25 m2/g which is herein after referred to as low surface area polymer (LSA-CPFA).

### Pore Size, Pore Volume and Specific Surface Area of Sorbents:

### Method for the Specific Surface Area Measurements:

Nitrogen adsorption measurements were performed at 77 K on a Quantachrome ASiQ. The mass of the sample used was between 0.2-1.0 g. Since the samples contain a significant amount of water, it is important to use a treatment that does not alter their intrinsic porosity and pore structure. Therefore, prior to degassing, the samples were treated using the elutropic row method, which comprises removing water and replacing it with organic solvents with lower boiling point in the following order: methanol, acetone, and n-heptane. 2 g of samples was place in a chromatography column with a frit and flushed with 20 cm3 of each solvent in decreasing polarity order. The sample was then spread out on a petri dish and placed in a vacuum oven at 40° C. for 24 hours. After that, the sample was degassed at 70° C. under vacuum for twelve hours before measurement.

BET (Brunauer, Emmett und Teller) surface area analysis was used applying the method ISO 9277.

Results for the specific surface area measurements are presented in FIG. 2 and are given in the below table 1:

TABLE 1
Specific surface area calculated and determined by
N2 adsorption measurements using the BET method.

| Sample ID | SBET/m² g⁻¹ |
|---|---|
| HSA-CPFA | 45 |
| LSA-CPFA | 7 |

Mercury Porosimetry Measurements:

Mercury porosimetry measurements were performed to analyze the pore sizes and pore volumes not accessible through N2 adsorption measurements. In order to perform mercury porosimetry measurements the following parameters were used:
Mercury surface tension: 0.48 N/m
Mercury contact angle: 150°
Test method: PASCAL (Pressurized by Automatic Speed-up and Continuous Adjustment Logic)
Max. pressure: 400 MPa
Increase speed: 6-19 MPa/min
Preparation: Degassing for 130 min. (also ensured <0.03 kPa reached)

Prior to Hg intrusion, the samples were degassed under vacuum at 70° C. for 12 h.

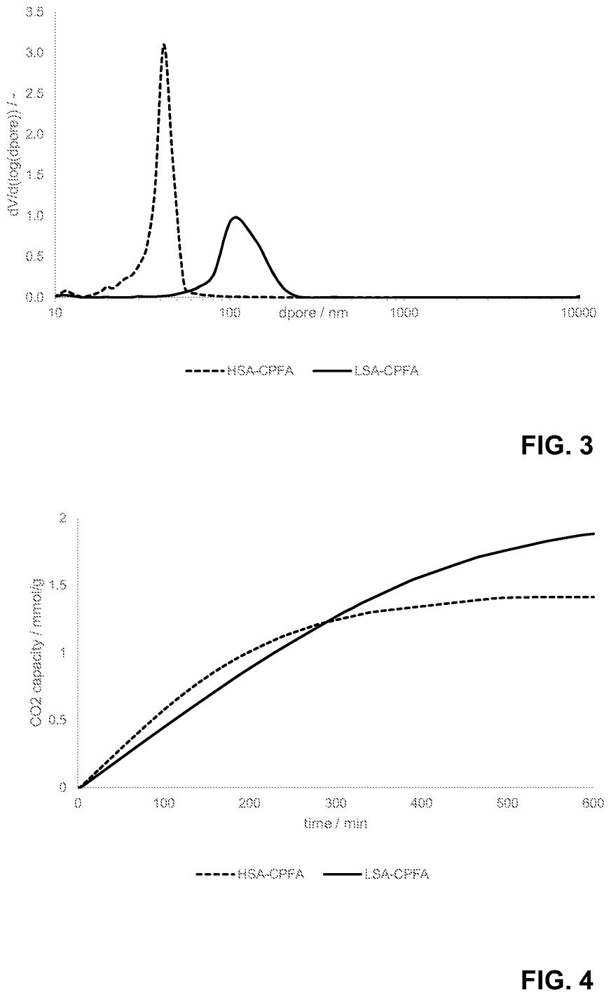

The results of Hg porosimetry analysis are presented in FIG. 3 and summarized in the following table 2:

TABLE 2
Porosity data obtained by Hg intrusion

| Sample ID | Total pore volume/cm³ g⁻¹ | Diameter pore/nm |
|---|---|---|
| HSA-CPFA | 0.57 | 20-60 |
| LSA-CPFA | 0.29 | 50-300 |

### Elemental Analysis:

Elemental analysis of the materials was carried out using a LECO CHN-900 combustion furnace. Prior to the measurement, the samples were treated under N2 flow (2 L/min) at 90° C. for 2 h.

TABLE 3
Elemental analysis results of HSA-CPFA

| Element | Nr. 1/wt. % | Nr. 2/wt. % | Nr. 3/wt. % | Average/wt. % |
|---|---|---|---|---|
| C | 79.70 | 80.41 | 78.55 | 79.55 |
| H | 8.06 | 8.10 | 8.43 | 8.01 |
| N | 8.46 | 8.43 | 7.91 | 8.27 |

TABLE 4
Elements analysis results of LSA-CPFA

| Element | Nr. 1/wt. % | Nr. 2/wt. % | Average/wt. % |
|---|---|---|---|
| C | 78.59 | 78.56 | 78.58 |
| H | 8.26 | 8.25 | 8.26 |
| N | 10.88 | 10.99 | 10.94 |

### Adsorption Measurements:

6 g of dry sample was filled into a cylinder with an inner diameter of 40 mm and a height of 40 mm and placed into a CO2 adsorption/desorption device, where it was exposed to a flow of 2.0 NL/min of air at 30° C. containing 450 ppmv CO2, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO2 adsorbed on the sorbent was determined by integration of the signal of an infrared sensor measuring the CO2 content of the air stream leaving the cylinder. The CO2 cumulative curves are shown in FIG. 4. As we can see, LSA-CPFA sorbent presents a much higher cumulative CO2 capacity compared to HSA-CPFA.

The results of the CO2 adsorption measurements are summarized in Table 5.

TABLE 5
CO2 adsorption capacity for the sorbents

| | CO₂ capacity/mmol |
|---|---|
| Sample ID | CO₂ per g of dry sorbent |
| HSA-CPFA | 1.4 |
| LSA-CPFA | 1.9 |

### Cyclic Adsorption/Desorption Measurements:

The cyclic adsorption/desorption capacity was measured in consecutive runs at relative humidity of the ambient air larger than 70%. The desorption process was performed using a warm fluid to increase the temperature of the sorbent. In this specific example, saturated steam was employed. The sorbent bed was first adsorbed for 120 min using ambient air.

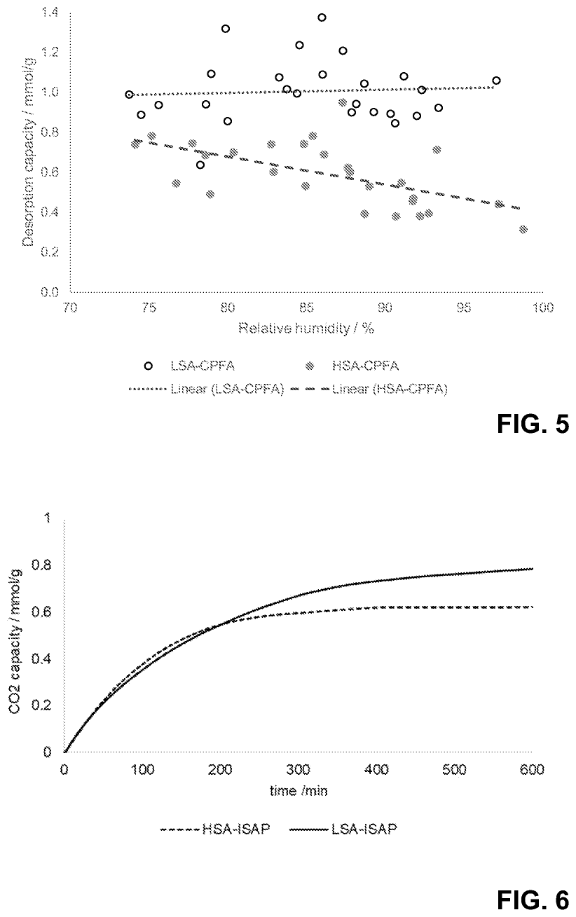

Once the adsorption was completed, the pressure of the system was brought down to 200 mbara. As soon as the pressure is reached, saturated steam is supplied to the sorbent bed up to reaching a temperature of ca 95° C. This cycle was repeated multiple times and the results for HSA-CPFA and LSA-CPFA are shown in FIG. 5.

By applying the aforementioned process and using air with RH in the range 75-99%, the desorption capacity of HSA-CPFA shows a constant decay. Within 25 cycles at high humidity it was observed a 50% decay, while the desorption capacity of LSA-CPFA shows a surprisingly stable outcome for at least 25 consecutive cycles at high relative humidity.

The sorbent material can generally also be a solid inorganic non-polymeric support material functionalized on the surface with amino functionalities capable of reversibly binding carbon dioxide, with a specific BET surface area, in the range of 1-20 m2/g.

Silica (SiO2), alumina (Al2O3), silica-alumina (SiO2-Al2O3), titania (TiO2), magnesia (MgO), clays, mixtures of the above are possible.

As for the organic polymeric materials, preferably for these organic or organic, non-polymeric support materials the total pore volume, measured by mercury intrusion, is in the range of 0.05-0-50 cm3/g and/or the pore diameter distribution, measured by mercury intrusion, is such that 90%, preferably 95% of the pore volume it is in the range of 50-300 nm.

For the case of silica microspheres having these porosity characteristics, they can be produced using the following scheme:

Monodisperse colloidal SiO2 was prepared by the seeded growth method. The seeds, commercially available Ludox AS-40 silica sol particles, were added to a mixture of ammonia (2 mol/L), deionised water (6 mol/L), and ethanol to form a suspension. Tetraethylorthosilicate (TEOS, 2.2 mol/L) was added to the mixture under stirring at a controlled speed while keeping the reaction mixture at 25° C. The monodisperse SiO2 particles were obtained by the growth of seeds. Monodisperse SiO2 microspheres with diameters of 500 nm were obtained and then calcined at 700° C. for 2 h, and followed by a hydrothermally treatment at 220° C. for 5 h to recover the surface silanol groups which were lost during the calcination.

The resulting silica material has a specific surface area of 10 m2/g, a median pore diameter of 95 nm, a total pore volume determined by Hg intrusion porosimetry of 0.23 cm3/g, and an average particle size of 500 μm.

For the case of alumina microspheres having these porosity characteristics, they are commercially available, for example, from Saint Gobain Nor Pro—catalyst carriers. Alpha-alumina not having surface hydroxyl groups can be used for modification by impregnation.

For the case of titania microspheres having these porosity characteristics, they are commercially available from Saint Gobain Nor Pro—catalyst carriers. Rutile titania not having surface hydroxyl groups can be used for modification by impregnation.

A method to prepare macroporous (anatase) TiO2 via hard templating with polystyrene microspheres is as follows:

290 nm polystyrene microspheres were obtained by first washing the styrene monomer with m1 of NaOH solution and distilled water for four times each until the pH value of styrene was neutral. Next, 160 m1 of distilled water and 6 m1 of washed styrene were introduced in a 250 m1 three-necked flask, and nitrogen was bubbled for 15 min to remove the oxygen in the system. Then the solution was heated to 70° C., and 10 m1 of K2S2O8 (0.007 g/mL) was added to the above solution. Under a nitrogen atmosphere, the reaction was continued for 28 h with vigorous magnetic stirring. A colloidal solution of polystyrene microspheres was obtained, followed by centrifuging and washing with deionized water and ethanol for three times. Finally, white powder PS microspheres were obtained after drying in air at 30° C. The macroporous titania is obtained by dissolving Ti(OC4H9)4 in anhydrous ethanol while stirring at 45° C. After that, deionized water and acetylacetone were added to the ethanol for a hydrolysis polycondensation reaction. 290 nm polystyrene microspheres were added to the solution. In this case, the molar ratio of the composition of the TiO2 sol was 1:25:2:1:0.2 of Ti(OC4H9)4:ethanol:H2O:acetylacetone:polystyrene microspheres. The resulting homogeneous composite sol was further stirred for 2 h at room temperature and aged for about 48 h, before calcination under pure oxygen at 500° C. for 3 hours. The final macroporous (anatase) titania has an average pore diameter (determined by Hg intrusion porosimetry) of 260 nm, a specific surface area of 42 m2/g and a pore volume (determined by Hg intrusion porosimetry) of 0.28 cm3/g.

For the case of clay having these porosity characteristics, they can be produced using the following scheme:

290 nm polystyrene microspheres are used as hard template for the preparation of macroporous clay particles. 3 g of polystyrene microspheres were added to 50 mL and sonicated for 10 min, then 6 g of kaolin powder was added and the solution further sonicated for 30 min. Then the solution was left to settle for 4 h before it was poured on a tray and dried for 24 h at 50° C., followed by calcination under pure oxygen at 600° C. for 5 hours. The final macroporous clay particles have an average pore diameter (determined by Hg) of 260 nm, a specific surface area of 20 m2/g and a pore volume (determined by Hg) of 0.2 cm3/g. Clays can be surface modified by impregnation.

Surface functionalisation of the solid inorganic or organic, non-polymeric or polymeric support material as defined above can generally be obtained by impregnation, or grafting.

Possible procedures are as follows:

Impregnation of solid inorganic or organic, non-polymeric or polymeric support material particles with amino-polymer:

For the preparation of 60 g of a sorbent with 20 wt. % low molecular weight polyethylenimine (PE1800, Mw=800, or PE12000, Mw=2000) loading on a support (e.g. silica or alumina or titania), to an aqueous mixture of 12 g of PE1800 or PE12000, 48 g of support are added and the suspension is stirred at 25° C. at 30 rpm for 3 h. After impregnation, the excess liquid is removed using a rotary evaporator set at 150 mbar and 50° C.

Grafting of an Amino-Polymer onto Silica Particles:

In a typical functionalization process, the silica particles are first dried for 12 h at 120° C. under vacuum. 2 g of dried silica are stirred with 200 mL of toluene for 3 hours, and then 1 g of 3-aminopropyltrimethoxysilane (APS) is added to the solution and stirred for 24 hours. The resulting material is then filtered, washed with 200 mL toluene, and dried for 12 h at 90° C. under vacuum at a pressure of ca. 100 mbar.

Specific example for an inorganic support material impregnated with an amino-polymer:

In this example section, two commercially available alumina supports have been impregnated with an amino-polymer according to the method detailed above. Those samples have been analyzed and compared: one with high surface area, having a BET surface area >25 m2/g, which is herein after referred to high surface area sorbent (HSA-ISAP, which stands for high-surface area inorganic supported amine polymer); and the second one with low surface area, <25 m2/g which is herein after referred to as low surface area sorbent (LSA-ISAP which stands for low-surface area inorganic supported amine polymer).

Results for the specific surface area measurements, with the measurement conditions as detailed above, are given in the below table 6:

TABLE 6
Specific surface area calculated and determined by
N2 adsorption measurements using the BET method.

| Sample ID | SBET/m² g⁻¹ |
|---|---|
| HSA-ISAP | 82 |
| LSA-ISAP | 10 |

The results of Hg porosimetry analysis, with the measurement conditions as detailed above, are summarized in the table 7: t,?

Table 7: Porosity data obtained by Hg intrusion

The results of the CO2 adsorption measurements, with the measurement conditions as detailed above, are summarized in Table 8. The CO2 cumulative curves are shown in FIG. 6.

TABLE 8
CO2 adsorption capacity for the sorbents
taken after 600 min of adsorption.

| | CO₂ capacity/mmol |
|---|---|
| Sample ID | CO₂ per g of dry sorbent |
| HSA-ISAP | 0.6 |
| LSA-ISAP | 0.8 |

LIST OF REFERENCE SIGNS

| | |
|---|---|
| 1 | ambient air, ambient air inflow structure |
| 2 | outflow of ambient air behind adsorption |
| | unit in adsorption flow-through mode |
| 3 | sorbent material |
| 4 | steam, steam inflow structure for desorption |
| 5 | reactor outlet for extraction |
| 6 | vacuum unit/separator |
| 7 | wall |
| 8 | reactor unit |

1. A method for separating gaseous carbon dioxide from a gas mixture,
said gas mixture containing said gaseous carbon dioxide as well as further gases different from gaseous carbon dioxide,
by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with said sorbent material to allow at least said gaseous carbon dioxide to adsorb on said sorbent material by flow-through through said unit under ambient atmospheric pressure conditions and ambient atmospheric temperature conditions in an adsorption step;
(b) isolating said sorbent material with adsorbed carbon dioxide in said unit from said flow-through while maintaining the temperature in said sorbent material;
(c) injecting a stream of saturated or superheated steam by flow-through through said unit and thereby inducing an increase of the temperature of said sorbent material to a temperature between 60 and 110° C., starting desorption of CO2;
(d) extracting at least desorbed gaseous carbon dioxide from said unit and separating gaseous carbon dioxide from steam by condensation downstream of said unit;
(e) bringing the sorbent material to ambient atmospheric temperature conditions;
wherein said sorbent material is a solid inorganic or organic, non-polymeric or polymeric support material functionalized on the surface with amino functionalities capable of reversibly binding carbon dioxide, with a specific BET surface area, in the range of 1-20 m2/g.

2. Method according to claim 1, wherein said sorbent material has a specific BET surface area, measured by nitrogen adsorption, in the range of 2-15 m2/g.

3. Method according to claim 1, wherein said sorbent material has a pore diameter distribution, measured by Mercury intrusion, such that 90% of the pore volume is in the range of 50-300 nm,
and/or wherein said sorbent material has a pore volume distribution, measured by Mercury intrusion, such that the maximum pore volume is at a pore diameter in the range of 80-150 nm,
and/or wherein said sorbent material has a total pore volume, measured by Mercury intrusion, in the range 0.05-0.50 cm3/g.

4. Method according to claim 1, wherein said sorbent material has a nitrogen content in the range 5-50 wt. % for dry sorbent material.

5. Method according to claim 1, wherein said gas mixture is ambient atmospheric air.

6. Method according to claim 1, wherein the solid inorganic or organic, non-polymeric or polymeric support material is
an organic or inorganic polymeric support.

7. Method according to claim 1, wherein the solid inorganic or organic, non-polymeric or polymeric support material is in the form of at least one of monolith, layer or sheet, hollow or solid fibres,
or wherein the solid inorganic or organic, non-polymeric or polymeric support material is in the form of solid particles embedded in a porous or non-porous matrix.

8. Method according to claim 1, wherein the gas mixture is passing through the sorbent material in step (a) with a relative humidity of at least 70%.

9. Method according to claim 1, wherein the sorbent material has a water retention in the range of 3-60 weight percent, and/or a bulk density (EN ISO 60 (DIN 53468)) in the range 750-400 kg/m3.

10. Method according to claim 1, wherein step (d) is carried out in that still contacting the sorbent material with steam by injecting and/or circulating saturated or superheated steam into said unit, thereby flushing and purging both steam and CO2 from said unit, while regulating the extraction and/or steam supply to essentially maintain the temperature in the sorbent at the end of the preceding step (c) and/or to essentially maintain the pressure in the sorbent at the end of the preceding step (c).

11. Method according to claim 1, wherein it is using a unit containing said sorbent material, the unit and the sorbent material being able to sustain a temperature of at least 60° C. for the desorption of at least said gaseous carbon dioxide and the unit being openable to flow-through of the gas mixture, and for contacting it with the sorbent material for the adsorption step.

12. Method according to claim 1, wherein said unit is evacuable to a vacuum pressure of 400 mbar(abs) or less, and wherein step (b) includes isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

13. Method according to claim 1, wherein step (e) is carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

14. Method of using a sorbent material having a solid inorganic or organic, non-polymeric or polymeric support material functionalized on the surface with amino functionalities capable of reversibly binding carbon dioxide, with a specific BET surface area, measured by nitrogen adsorption, in the range of 1-20 m2/g, for separating gaseous carbon dioxide from a gas mixture.

15. Unit for separating gaseous carbon dioxide from a gas mixture, comprising at least one reactor unit containing sorbent material suitable and adapted for flow-through of said gas mixture,
wherein the reactor unit comprises an inlet for said gas mixture, and an outlet for said gas mixture, during adsorption,
wherein the reactor unit is heatable to a temperature of at least 60° C. for the desorption of at least said gaseous carbon dioxide and the reactor unit being openable to flow-through of the gas mixture, and for contacting it with the sorbent material for an adsorption step.

16. Method according to claim 1, wherein said sorbent material has a specific BET surface area, measured by nitrogen adsorption, in the range of 4-10 m2/g.

17. Method according to claim 1, wherein said sorbent material has a pore diameter distribution, measured by Mercury intrusion, such that 95% of the pore volume is in the range of 50-300 nm, or in the range of 50-250 nm,
and/or wherein said sorbent material has a pore volume distribution, measured by Mercury intrusion, such that the maximum pore volume is at a pore diameter in the range of 100-150 nm, wherein 90% or 95% of the total pore volume of the distribution is in a window of −50 nm and +150 nm around the diameter of said maximum of the pore volume distribution
and/or wherein said sorbent material has a total pore volume, measured by Mercury intrusion, in the range 0.15-0.35 cm3/n.

18. Method according to claim 1, wherein said sorbent material has a nitrogen content in the range 9-15 wt. % or 10-12 wt. %, in each case for dry sorbent material.

19. Method according to claim 1, wherein the solid inorganic or organic, non-polymeric or polymeric support material is
an organic polymeric support, in particular a polystyrene based material, including a styrene divinylbenzene copolymer, to form the sorbent material surface functionalised with primary amine, including methyl amine and benzylamine moieties,
or is a non-polymeric inorganic support, selected from the group consisting of: silica (SiO₂), alumina (Al₂O₃), titania (TiO₂), magnesia (MgO), clays, as well as mixed forms thereof, including silica-alumina (SiO₂—Al₂O₃), or mixtures thereof.

20. Method according to claim 1, wherein the solid inorganic or organic, non-polymeric or polymeric support material is styrene divinylbenzene copolymer, to form the sorbent material surface functionalised with benzylamine moieties, and wherein the solid polymeric support material is obtained in an emulsion polymerisation process.

21. Method according to claim 1, wherein the solid inorganic or organic, non-polymeric or polymeric support material is in the form of at least one of monolith, layer or sheet, hollow or solid fibres in woven or nonwoven structures, hollow or solid particles in the form of essentially spherical beads with a particle size (D50) in the range of 0.30-1.25 mm.

22. Method according to claim 1, wherein the gas mixture is passing through the sorbent material in step (a) with a relative humidity of at least 75%.

23. Method according to claim 1, wherein the sorbent material has a water retention in the range of 3-30 weight percent or 5-30 weight percent and/or a bulk density (EN ISO 60 (DIN 53468)) in the range 450-650 kg/m3.

24. Method according to claim 11, wherein the unit comprises an array of individual adsorber elements, each adsorber element comprising at least one support layer and at least one sorbent layer comprising or consisting of at least one sorbent material, where said sorbent material offers selective adsorption of CO2 in the presence of moisture or water vapor, wherein the adsorber elements in the array are arranged essentially parallel to each other and spaced apart from each other forming parallel fluid passages for flow-through of gas mixture.

25. Method according to claim 1, wherein said unit is evacuable to a vacuum pressure of 400 mbar(abs) or less, and wherein step (b) includes isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions, and wherein after step (d) and before step (e) the following step is carried out:
(d1) ceasing the injection and, if used, circulation of steam, and evacuation of the unit to pressure values between 20-500 mbar(abs), or in the range of 50-250 mbar(abs) in the unit, thereby causing evaporation of water from the sorbent and both drying and cooling the sorbent.

26. Method according to claim 14, using a temperature, vacuum, or temperature/vacuum swing process, including using a process in which injecting a stream of saturated or superheated steam by flow-through is used for inducing an increase of the temperature of the sorbent material to a temperature between 60 and 110° C., starting the desorption of CO2.

27. Unit according to claim 15, wherein at the gas outlet side of said device for separating carbon dioxide from water, there is at least one of a carbon dioxide concentration sensor and a gas flow sensor for controlling the desorption process.
